(19) United States
(12) Patent Application Publication
(10) Pub. No.: US 2014/0324928 A1
(43) Pub. Date: Oct. 30, 2014

(54) LARGE-SCALE DATA TRANSFER

(71) Applicant: Hewlett-Packard Development Company, L.P., Fort Collins, CO (US)

(72) Inventors: Christopher Lynn Tinker, Alpharetta, GA (US); Gregory Lyle Tinker, Alpharetta, GA (US)

(73) Assignee: Hewlett-Packard Development Company, L.P., Fort Collins, CO (US)

(21) Appl. No.: 13/872,484

(22) Filed: Apr. 29, 2013

(51) Int. Cl. G06F 17/30

(52) U.S. Cl. CPC G06F 17/30194
USPC 707/827

(57) ABSTRACT

Data transfer is disclosed, for example as the data transfer may be implemented to transfer large sets of data from source file system to a destination file system. An example method may include determining an architecture of a data set to be transferred from a source file system via a dynamic parallel scan. The method may also include scheduling a plurality of the file serving nodes to transfer the data set from the source file system to a destination file system. The method may also include identifying changes to the data set of the source file system, the changes occurring as the data set is transferred to the destination file system. The method may also include based on the changes, updating the data set at the destination file system.

### BACKGROUND

Data storage capability has continued to increase as the cost of physical storage has decreased. As a result, large amounts of data have been stored over the past decades. It is not uncommon for an individual enterprise to have thousands of terabytes (TB) of electronically stored data. For example, financial institutions store most (if not all) transactions and other customer records even after the customer is no longer with the financial institution. Many of these records are stored as relatively small files. For example, individual file sizes may be 1-2 kilobytes (KB). Thus, a 2,000 TB data set stored by the financial institution may include 40 million or more individual files.

While new hardware and software systems come available for more effectively managing enterprise data, many enterprises cannot change and are “stuck” using outdated systems, because moving the large amount of stored data that has accumulated over the years is a nearly impossible task. For example, backing up a 2,000 TB data set that has over 40 million individual files, and then restoring the data set on another system, can easily take 30 days or longer. During this time, users are unable to access any of the data due to the nature of backup and restore operations. Shutting down for this length of time is simply not feasible for most enterprises that are expected to provide customers and other users with access to stored data without any (or only minimal) interruption.

Large data sets pose challenges associated with movement of data and replication methodologies. The seemingly simple act of copying a data structure from one location to another becomes a substantial time challenge when dealing with many (e.g., millions of or even more) files.

### BRIEF DESCRIPTION OF THE DRAWINGS

FIG. 1 is a block diagram of an example computer system which may be implemented to transfer a data set from a source file system to a destination file system.

FIGS. 2a-b are high-level illustrations showing an example transfer operation.

FIG. 3 shows an example architecture of machine readable instructions, which may be executed to transfer a data set from a source file system to a destination file system.

FIG. 4 is a process diagram illustrating an example configuration of threaded data transfer.

FIG. 5 is a flowchart illustrating example operations which may be implemented to transfer a data set from a source file system to a destination file system.

### DETAILED DESCRIPTION

Leveraging existing backup solutions to transfer large data sets can be prohibitive for many enterprises. For example, a financial institution may have upwards of 50TB of records stored in an existing file system. It can take 10 days or more to backup 50TB of data on the existing file system, and then restore the backed up data to a new file system, even if both file systems reside in the same datacenter, or even on the same host or cluster.

The serial nature of backup and restore operations introduces a significant source of delay when transferring large data sets. Block level replication methods significantly increase the performance achievable for moving large amount of data; however, with the introduction of newer clustered file systems, the dispersion of data over various block devices significantly complicates this method. Additionally, if an array-based thinning technology is leveraged, the block level copy may initialize all of the thin capacity, thereby rendering all provisioned capacity as thick capacity and producing a storage management complication. Even if these hurdles are met, the re-stitch of the clustered file system poses a significant challenge which is exponentially complicated with the more block device for which the file system is dispersed over.

The quantity and size of file directly affect the efficiency of the operation. For example, a large data set including small files means that there are many files (e.g., millions of 1-2 KB files) that have to be backed up and then restored. Furthermore, each directory may only store one (or a few) files, increasing the size of the directory structure that has to be backed up and restored. Backing up and then restoring such a massive directory structure increases the time it takes to complete the process. As such, existing backup solutions simply do not offer the ability to transfer large data sets from one file system to another (e.g., from a legacy file system to a new file system) in a fast and efficient manner. It could also be that a source system is problematic or systematically inducing failures that are impacting the business by limiting or hampering data availability and access. For example, if a repair has to be made to the underlying backing store resulting in an offline period, the production data has to be migrated to a new system in order for the repairs to be mad, and then migrated back.

In addition, backup and restore operations typically have to be executed in isolation, such that users cannot access the data during the backup and restore operations. Enterprises that maintain large data sets are often forced to shut down for long periods of time (e.g., days, weeks, or longer) to transfer a large data set from an existing file system to a new file system using traditional backup and restore operations. More likely shutting down is not an option, and the enterprise is unable to transfer their data to the new file system. Instead, the enterprise is left using an outdated (perhaps older and/or slower) data management system because the data set cannot be quickly and efficiently transferred to the new file system.

Large-scale data transfer is disclosed herein which may be used to transfer large data sets (e.g., move, copy, synchronize, or otherwise transfer data) from a source file system to a destination file system, without invoking backup and restore techniques. The transfer operation may be followed by an update operation to ensure that any files changed on the source file system during the transfer operation, the changes are reflected on the destination file system after the transfer operation is completed.

In an example, the data transfer operation may be implemented in two stages. In a first stage, a seeding operation, bulk data may be transferred. In the second stage, an update or synchronization stage, the customer shuts down production, and verifies that the target has all the data. The customer is then notified when the target is ready for data access by end users.

The data transfer operates at the individual file level, enabling continued access to the source file system even during the transfer operation. In an example, the transfer operation leverages threads to facilitate the manipulation of very large datasets at an individual file level. Therefore, the transfer operation may be deployed to transfer large data sets without interrupting user access to the data set. Operating at the individual file level also increases the speed with which the transfer operation can be completed.

Moving the data set to the destination file system may be accomplished as a one-time event or as a staged event (e.g., multiple separate events occurring as single events at distinct times). The data set at the destination file system can be updated after all of the data set is transferred to the destination file system. Accordingly, the data set can be quickly and efficiently transferred from a source file system to a destination file system, without having to block access to the data for extended times.

Before continuing, it is noted that as used herein, the terms “includes” and “including” mean, but is not limited to, “includes” or “including” and “includes at least” or “including at least.” The term “based on” means “based on” and “based at least in part on.”

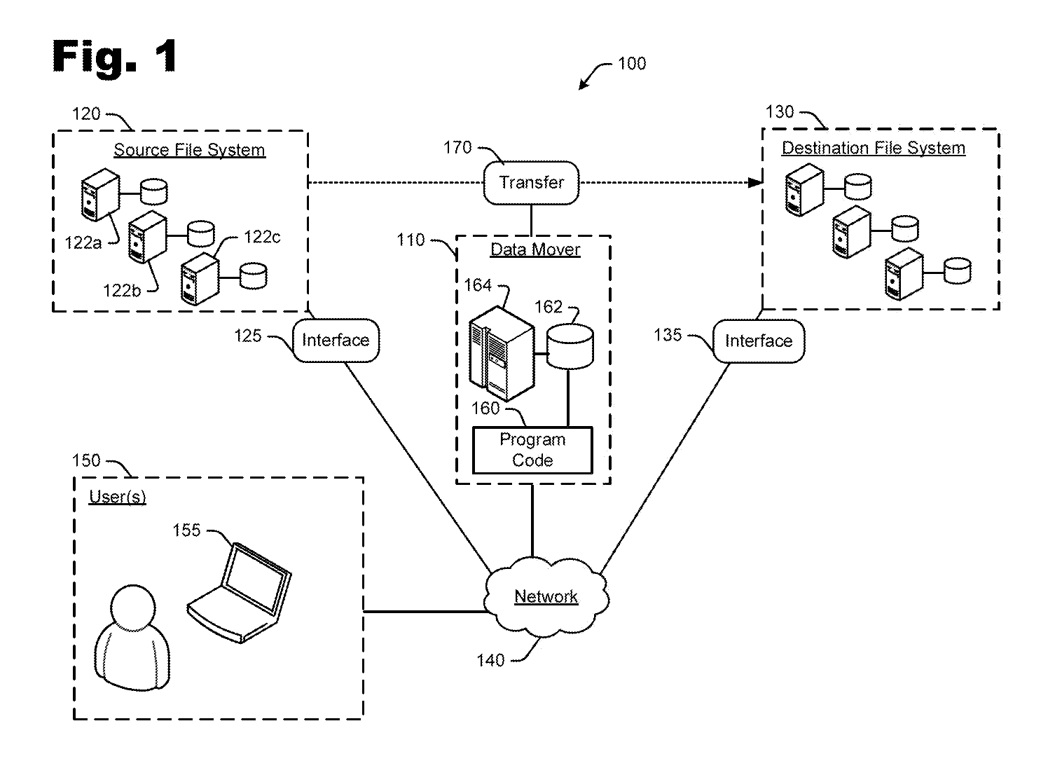

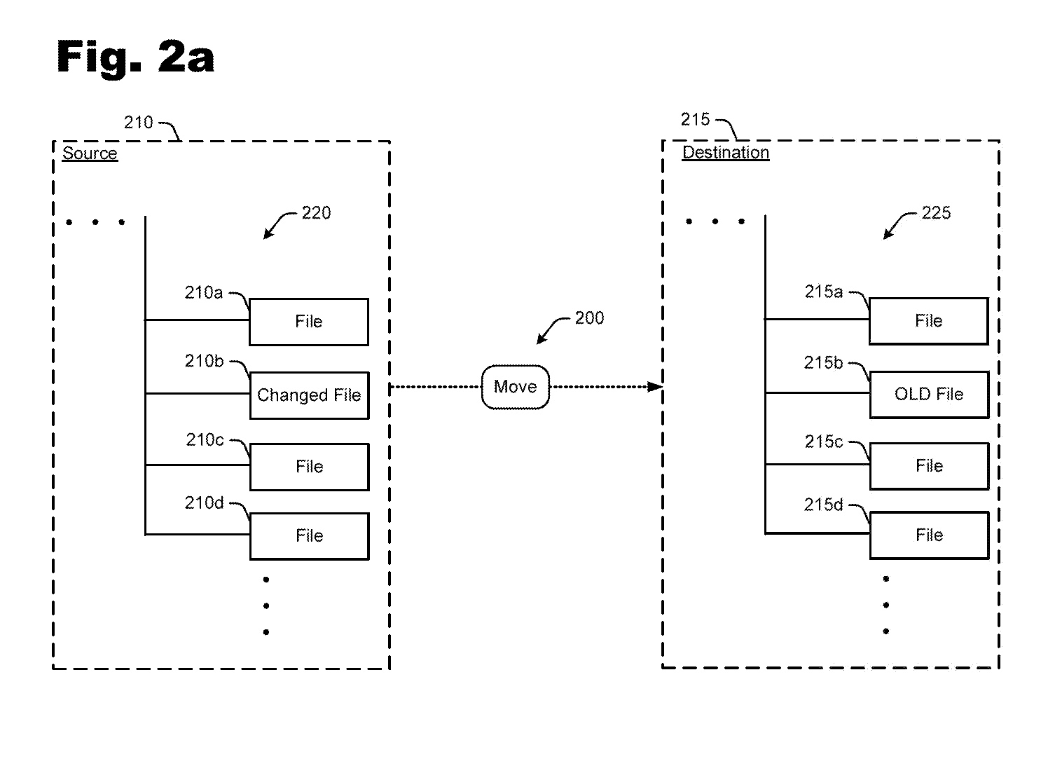

FIG. 1 is a block diagram of an example computer system 100 which may be implemented with a transfer tool 110 to transfer a data set from source file system 120 to a destination file system 130. System 100 may be implemented with any of a wide variety of computing devices, such as, but not limited to, server computers, blade servers, storage servers, and storage appliances (e.g., devices dedicated to providing storage), to name only a few examples of suitable computing devices. Each of the computing devices may include memory, storage, and a degree of data processing capability at least sufficient to manage a communications connection either directly with one another or indirectly (e.g., via a network 140). At least one of the computing devices is also configured with sufficient processing capability to execute the program code described herein.

It is noted that transfer tool 110 is shown in FIG. 1 being separate from the source file system 120 for purposes of illustration and clarity. However, the physical location of the transfer tool 110 is not limited and may reside on the source file system 120, and/or partially on the source file system 120. In addition, the destination file system 130 is shown in FIG. 1 being separate from the source file system 120 for purposes of illustration and clarity. However, the physical location of the destination file system 130 is not limited and may co-exist with the source file system 120 (e.g., in the same data center).

In an example, the source file system 120 may be an existing file system used by an enterprise for providing a service to user(s) 150 via client device(s) 155. It is noted that the source file system 120 may be configured as a clustered file system. Using a clustered file system, the transfer tool described herein may leverage the cluster nodes of the source file system 120 to further expedite transferring the files.

The destination file system 130 may be provided for a new data management system for the enterprise. Example services provided by the enterprise may include, but are not limited to financial services and retailer services, in which large data sets (e.g., customer records) are maintained as files in the file system 120. The file systems 120, 130 may include interfaces to application programming interfaces (APIs) and related support infrastructure, such as application engines and hosted business services.

For purposes of illustration, the file systems 120, 130 may be online data processing systems executing on a host configured as computing node(s) each managing computer-readable storage in the file systems 120, 130. The data may be stored as individual files in a directory structure, and may include public and/or private data that is hosted on the Internet or as dynamic data endpoints for any number of client applications in a network.

The file systems 120, 130 may include local and/or remote sources of data. Accordingly, file serving nodes 122a-c may be operable to communicate with at least one remote data source. That is, the storage may be directly attached to one of the file serving nodes 122a-c, and/or the storage may be physically distributed in a network and operatively associated with the file serving nodes 122a-c. In any implementation, the storage may include any type of data. For example, the storage may include databases for providing information, applications for providing application data, storage resources for providing online storage facilities. There is no limit to the type or amount of data that may be maintained by the file systems 120, 130. In addition, the data may include unprocessed or “raw” data, or the data may undergo at least some level of processing. Taken as a whole, the data stored in the file systems 120, 130 is referred to herein as “data set(s).”

Often, these data sets have to be provided by the source file system 120 to users 150 on an ongoing, substantially uninterrupted basis. Although short outages may be tolerated, access to the data sets via the source file system 120 cannot be suspended for days, weeks, or even longer periods of time, while a data set is being transferred to the destination file system 130.

From time to time, however, various new hardware and software solutions may come available to more effectively manage the data sets for an enterprise and/or for the enterprise to provide a service to its users 150. The new hardware and/or software solution may have its own file system (e.g., destination file system 130). The enterprise should not be “stuck” using the source systems simply because a large amount of data that has accumulated in the file system 120 has to be transferred to the new file system 130.

Backing up a 2,000TB data set with over 40 million individual files can easily take 30 days or longer using traditional backup and restore solutions. During this time, it may be unacceptable to take the source file system 120 offline to transfer the data set to the destination file system 130.

The transfer tool 110 leverages native file system parameters and dynamically tunable parallelism to facilitate the manipulation of very large data sets at an individual file level. Moving a large number of files (e.g., millions of files) at the individual file level eliminates the need to backup and restore the files as a block. Accordingly, the data set can be transferred from the source file system 120 to the destination file system 130 while minimizing or mitigating (e.g., allowing read-only) user access to the data set during the transfer operation. The transfer tool 110 may also utilize common industry practices concerning single name space file systems. Accordingly, the data set can be quickly and efficiently transferred from a source file system to a destination file system.

In an example, the transfer tool 110 may be implemented as a software tool or utility. That is, the transfer tool 110 may be embodied as program code 160 stored on a non-transitory computer-readable medium 162 and executable by a processor 164. The transfer tool 110 may also leverage a dynamic number of threads in the source file system 120 to manage large data sets including many (e.g., millions) of files. That is, the transfer tool 110 can be executed in distributed processing environments.,

By way of illustration, there may be M×N program threads, where M is the number of local threads (typically a plurality or “many”) and N is the number of nodes. The sum of the parallelism is calculated by summing the number of threads per node. The number of threads per node may be dynamically tunable, fixed, and/or can vary from node to node.

A distributed processing environment includes program code 160 that is executed by a plurality of processing nodes in a networked computer system, such as by executing the program code 160 across multiple file serving nodes 122a-c in the source file system 120. For example, the network computer system may be cloud-based, wherein the program code is executed on a primary computing device, but has access to input/output from other code fragments executing elsewhere in the cloud computing system.

In an example, the transfer tool 110 may be implemented in a distributed processing environment via a message passing interface (MPI). The MPI enables workload to be spread amongst multiple of the file serving nodes 122a-c. Accordingly, the transfer tool 110 is able to transfer data from the source file system 120 to the destination file system 130 at a fast rate using the local file serving nodes 122a-c.

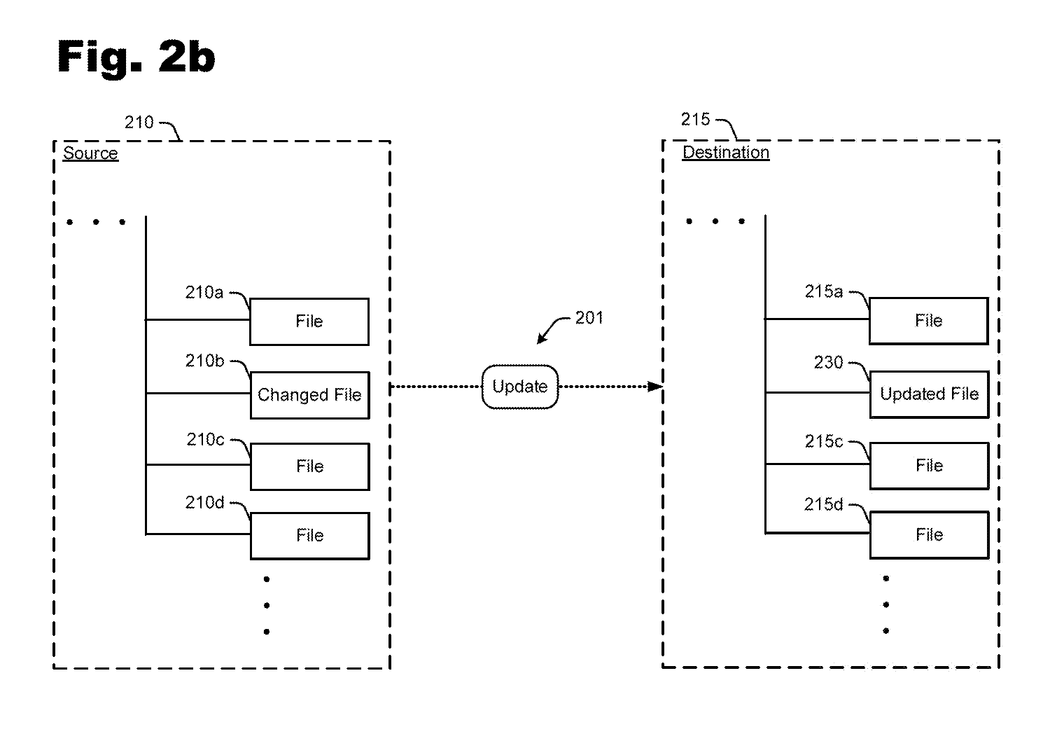

As mentioned above, the program code 160 may be executed by any suitable computing device(s) to transfer a data set on an individual file basis from the source file system 120 to the destination file system 130. Although the example transfer operation 170 is illustrated in FIG. 1 as occurring directly between the source file system 120 and the destination file system 130, it is noted that the actual file transfer occurs via standard call( ) interfaces 125 and 135 over network 140. Transfer operations can be better understood with reference to FIG. 2 and the following discussion of various example functions.

FIGS. 2a-b are high-level illustrations showing an example transfer operation 200. It is noted that the operations described with reference to FIGS. 2a-b are not limited to any specific implementation with any particular type of data set.

In FIG. 2a, a portion of the source file system 210 is shown as it may include a number of individual files 210a-d in a directory tree structure 220. It is noted that an actual data set may include many more files and more elaborate directory tree structures than shown in FIG. 2a. For example, a source file system 210 may include a 40TB data set with a complex directory tree structure, including millions of individual files of any size (although 1-2 KB file sizes are common).

Although an exclusion list may be implemented, the transfer tool generally operates on all of the files, on an individual file basis. For example, corresponding files 215a-d are shown in directory tree structure 225 in the destination file system 215.

By moving each of the files 210a-d on an individual basis, users continue to have access to any of the files 210a-d in the source file system 210 during the transfer operation 200. As such, one or more of the files 210a-d may be changed/modified or deleted in the source file system 210, as illustrated by changed file 210b in the source file system 210. If the file 210b changes after the file 210b has already been transferred to the destination file system 215, then the corresponding file 215b in the destination file system 215 does not reflect the original data.

FIG. 2b illustrates an example update operation, which may be executed after all of the files in the source file system 210 have been transferred to the destination file system 215. The transfer operation may identify any changes to the data set in the source file system 210, and then make corresponding changes to the destination file system 210. In FIG. 2b, updated file 230 is shown in the destination file system 215 corresponding to the changed file 210b in source file system 210.

Updates may occur according to any suitable mechanism. For example, changes may be monitored on an ongoing basis during the transfer operation. Or for example, changes may be identified following the transfer operation. In an example, changes that occur to individual files in the data set of the source file system are maintained in a log. For example, the data set at the destination file system may be updated based on comparing a time stamp of data at the destination file system with the log to determine which files have changed in the data set at the source file system 210. The transfer operation then transfers only the changed files to the destination file system 215, as illustrated by update operation 201 in FIG. 2b, following the initial transfer operation (e.g., illustrated in FIG. 2b).

In an example, user access to the data set in the source file system 210 may be temporarily blocked so that all changes can be reconciled. When access to the data set is reestablished, users are directed to the data set in the destination file system 215. Accordingly, the changeover appears seamless to the users. In other examples, the update may be iterative, thus allowing ongoing access to the data set even during an update operation.

The operations described with reference to FIGS. 2a-b may be performed by program code implemented in machine-readable instructions (such as but not limited to, software or firmware). The machine-readable instructions may be stored on a non-transient computer readable medium and are executable by one or more processor to perform the operations described herein.

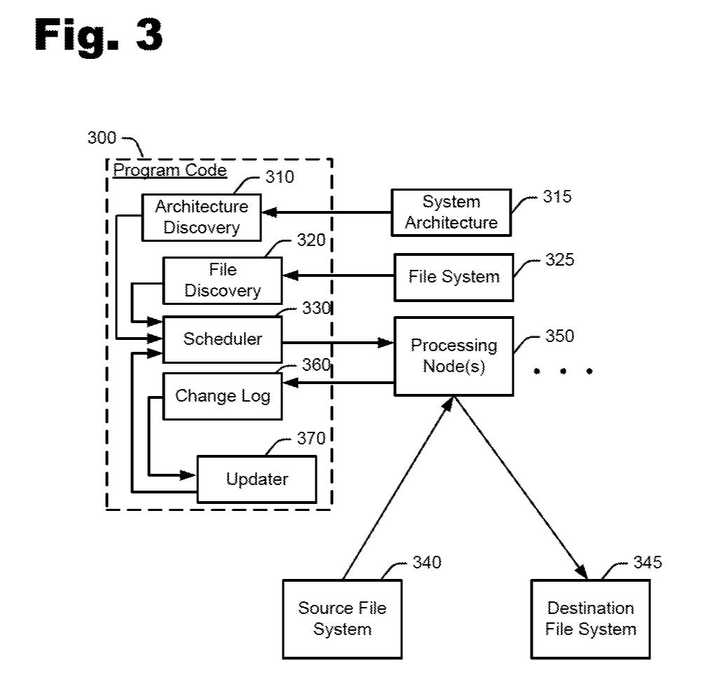

An example of program code which may be implemented is illustrated in FIG. 3. It is noted, however, that the components shown in FIG. 3 are provided only for purposes of illustration of an example operating environment, and are not intended to limit implementation to any particular system.

FIG. 3 shows an example architecture of machine readable instructions, which may be executed to transfer a data set from a source file system to a destination file system. Program code 300 executes the function of the architecture of machine readable instructions as self-contained modules. These modules can be integrated within a self-standing tool, or may be implemented as agents that run on top of an existing program code to leverage a dynamic number of threads to transfer large data sets including many (e.g., millions of) files.

In an example, the program code 300 includes an architecture discovery module 310. Architecture discovery module 310 determines an architecture of file serving nodes for a data set to be transferred from a source file system 340. In an example, architecture data 315 may be supplied via a configuration file. System architecture data 315 may be provided by computing devices in the source file system (e.g., the file serving nodes).

The program code 300 also includes a file discovery module 320. The file discovery module 320 and scheduler 330 operate to significantly change how a data transfer is conducted. It is noted that the scheduler is a massively parallel threaded engine, which significantly speeds the process of discovery. Afterwards, the transfer tool engages inner process communication with other nodes, and significantly paralyzes the data transfer mechanism to the destination file system.

File system information 325 may also be provided by computing devices in the source file system (e.g., the file serving nodes). The file system information 325 may include the structure of the data set to be transferred, such as but not limited to, directory tree structure, number of files per directory in the directory tree structure, total number of files, and file size.

The architecture discovery module 310 may crawl the file system in an ever advancing thread count. That is, a maximum number of threads may be set which allows crawling or discovering a file system metadata faster than any conventional tools. For example, a conventional “find” command may take two full days, whereas the architecture discovery module 310 can reduce this time to a matters of hours or even less.

The architecture discovery module 310 and file discovery module 320 may feed information to a scheduler 330. Scheduler 330 may schedule a plurality of processing nodes 350 (e.g., file serving nodes in the source file system) to transfer the data set to a destination file system 345. Any changes occurring to files in the source file system 340 may be logged, e.g., in change log 360. Change log 360 may be implemented as a database which tracks file metadata attributes for later comparison. Information in the change log 360 may be provided to an updater module 370. Updater module 370 updates the data set at the destination file system 345 after the data set is transferred to the destination file system 345. Accordingly, the data set can be transferred to the destination file system 345, and then updated based on changes to the data set of the source file system 340 that occurred while the data set was being transferred to the destination file system 345.

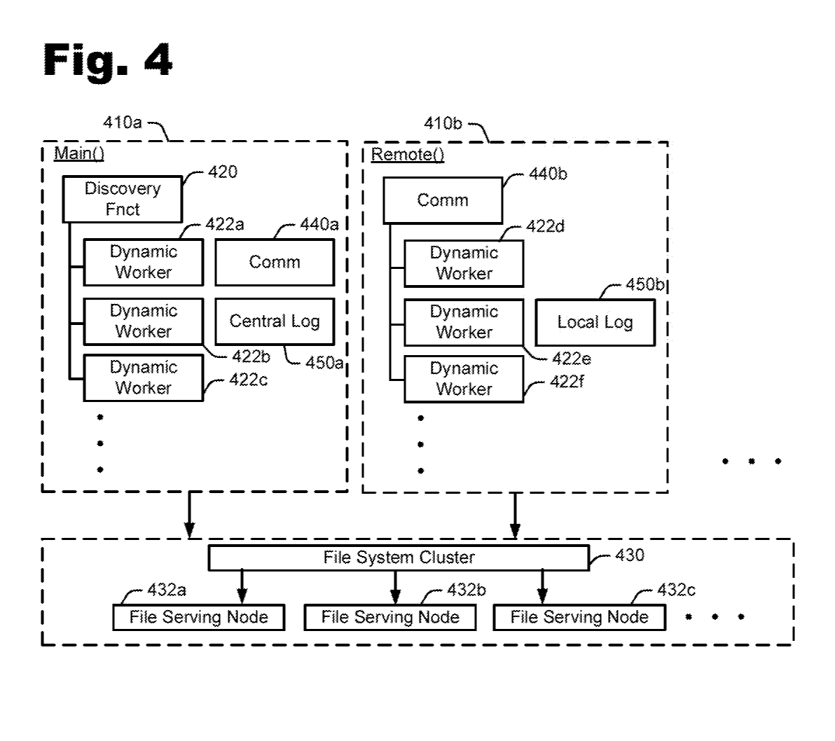

Although the program code is shown in FIG. 3 as a single architecture, the program code may be executed in a distributed processing environment, for example, executing on multiple file serving nodes in the source file system 340. Accordingly, the program code may be executed to leverage the power and speed of today's processing and network capabilities to enhance the transfer operation described herein. An example of the transfer operation as it may be executed in a distributed processing environment is described below with reference to FIG. 4.

FIG. 4 is a process diagram illustrating an example configuration of a threaded data transfer 400. As noted above, the transfer operation is able to execute in a distributed environment on the same the system structure, by communicating to other portions of the program code running on other computing nodes in the source file system. Accordingly, the transfer operation is able to leverage the power already available in a server farm to get the job done nearly linearly faster.

In the illustration shown in FIG. 4, a primary thread 410a executes the program code. Primary thread 410 may execute a discovery function 420 to identify subordinate threads (e.g., thread 410b). For example, the discovery function 420 may interrogate the file system cluster 430 (including file serving nodes 432a-c for the source file system) at the kernel level to determine the number of threads that are available to execute program code for the transfer operation. The threads are maintained as a list of dynamic workers 422a-c that are available to execute the program code in a distributed manner.

It is noted that any number of threads may be selected from the file serving nodes to execute the program code described herein. In addition, the number of threads that are available may be dynamic (i.e., changing with respect to time) based on other requirements of the system (e.g., user access to the data set). For example, more threads may be available during off-peak hours.

The program code may also be executed by the subordinate threads (e.g., thread 410b). During operation, the threads 410a-b may communicate with one another (e.g., via communication object 440a-b). For example, thread 410b may communicate a list of dynamic workers 422d-f back to thread 410a for scheduling during a transfer operation.

During the transfer operation, the available threads (e.g., all or a subset of threads on the nodes 432a-c) are scheduled to transfer the data set from the source file system to the destination file system. For example, threads may be scheduled among the plurality of file serving nodes 432a-c based on a number of threads that are available at any given time to transfer the data set.

Executing the program code may instantiate a transfer interface configured to read the data set via a file system driver for the source file system, and then write the data set to the destination file system, via a file system driver. Moving the data set to the destination file system may be accomplished as a one-time transfer event. The data set at the destination file system can be updated after all of the data set is transferred to the destination file system.

A log may be maintained for changes that occurred to individual files in the data set of the source file system during the transfer operation. For example, the primary node 410 may maintain a central log of changes, and each subordinate node 410b may maintain a local log 450 of changes that are reported via communication object 440a-b to the primary node 410a for storing in the central log. Subordinate nodes 410b may then he scheduled based on information in the central log for an update operation.

The transfer operation updates the data set at the destination file system based on changes to the data set of the source file system occurring as the data set is transferred to the destination file system. For example, the data set at the destination file system may be updated based on comparing a time stamp of data at the destination file system with the log to determine changes to the data set.

The transfer operation may also provide various other functions to accomplish a fast, efficient migration, replication, relocation, and/or transfer of “big data” file configurations. In an example, moving the data set to the destination file system may be implemented at an individual file for directory) level without having to transfer an entire data set as a block.

Before continuing, it should be noted that the examples described above are provided for purposes of illustration, and are not intended to be limiting. Other devices and/or device configurations may be utilized to carry out the operations described herein.

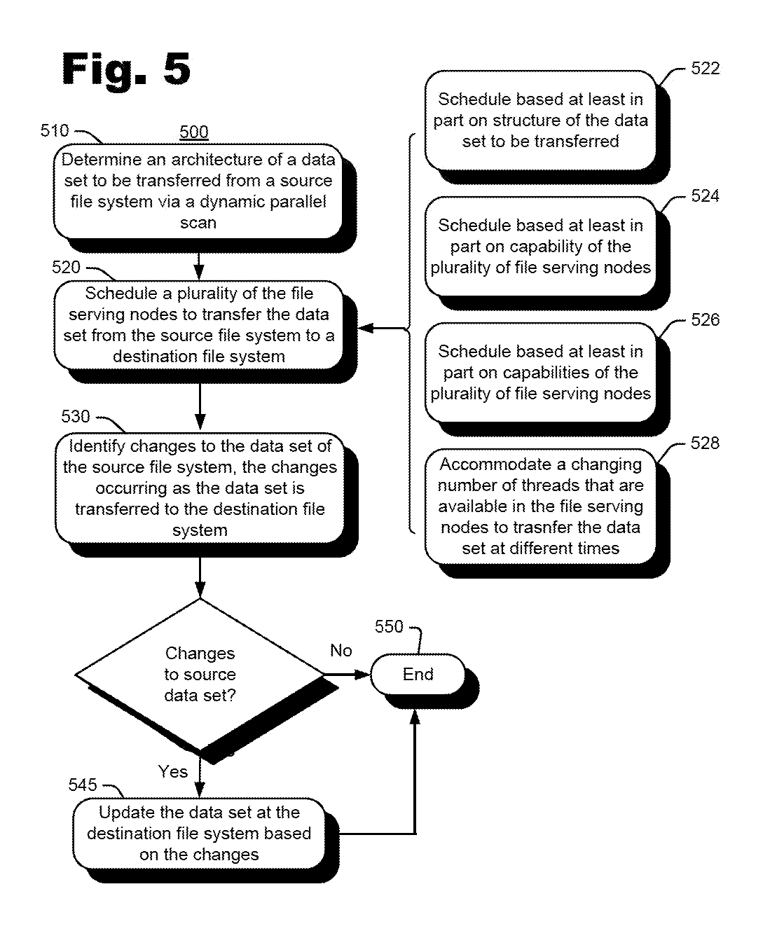

FIG. 5 is a flowchart illustrating example operations which may be implemented to transfer a data set from source file system to a destination file system. Operations 500 may be embodied as logic instructions on one or more computer-readable medium. When executed on a processor, the logic instructions cause a general purpose computing device to be programmed as a special-purpose machine that implements the described operations. In an example, the components and connections depicted in the figures may be used.

Example operation 510 includes determining an architecture of a data set (e.g., by discovery) to be transferred from a source file system via a dynamic parallel scan. Example operation 520 includes scheduling a plurality of the file serving nodes to transfer the data set from the source file system to a destination file system. It is noted that moving the data set to the destination file system can be accomplished without interrupting access to the data set of the source file system. That is, the data set does not have to be taken offline, and users may continue to use the data set even during a transfer operation.

By using the data set during the transfer operation, various files may be changed on the source file system, and thus need to be updated for the destination file system. Updating the data set at the destination file system may occur after moving the entire data set to the destination file system. Example operation 530 includes identifying changes to the data set of the source file system, the changes occurring as the data set is transferred to the destination file system. If there are changes at decision point 540, example operation 545 includes updating the data set at the destination file system based on the changes. Operations may end at block 550, wherein the transfer is considered complete.

The operations shown and described herein are provided to illustrate example implementations. It is noted that the operations are not limited to the ordering shown. Still other operations may also be implemented.

Further example operation 522 includes scheduling the plurality of file serving nodes is based at least in part on structure of the data set to be transferred. The structure of the data set to be transferred may include directory tree structure, number of files per directory in the directory tree structure, total number of files, and/or file size. Further example operation 524 includes scheduling the plurality of file serving nodes is based at least in part on capability of the plurality of file serving nodes. Further example operation 526 includes scheduling the plurality of file serving nodes is based at least in part on capabilities of the plurality of file serving nodes. Further example operation 528 includes scheduling includes accommodating a changing number of threads that are available in the file serving nodes to transfer the data set at different times.

The operations may be implemented at least in part using an end-user interface (e.g., web-based interface). In an example, the end-user is able to make predetermined selections, and the operations described above are implemented on a back-end device (e.g., a server system executing the program code described herein) to present results to a user. The user can then make further selections. It is also noted that various of the operations described herein may be automated or partially automated.

It is noted that the examples shown and described are provided for purposes of illustration and are not intended to be limiting. Still other examples are also contemplated.

1. A large-scale data transfer method, comprising:
determining an architecture of a data set to he transferred from a source file system via a dynamic parallel scan;
scheduling a plurality of the file serving nodes to transfer the data set from the source file system to a destination file system;
identifying changes to the data set of the source file system, the changes occurring as the data set is transferred to the destination file system; and
updating the data set at the destination file system based on the changes.

2. The method of claim 1, wherein scheduling the plurality of file serving nodes is based at least in part on structure of the data set to be transferred.

3. The method of claim 1, wherein the structure of the data set to be transferred includes: directory tree structure, number of files per directory in the directory tree structure, total number of files, and file size.

4. The method of claim 1, wherein scheduling the plurality of file serving nodes is based at least in part on capability of the plurality of file serving nodes.

5. The method of claim 1, wherein scheduling includes accommodating a changing number of threads that are available in the file serving nodes to transfer the data set at different times.

6. The method of claim 1, wherein scheduling the plurality of file serving nodes is based at least in part on capabilities of the plurality of file serving nodes.

7. The method of claim 1, wherein updating the data set at the destination file system is after moving the entire data set to the destination file system.

8. The method of claim 1 further comprising moving the data set to the destination file system without interrupting access to the data set of the source file system.

9. The method of claim 1, wherein moving the data set to the destination file system is by a single transfer operation followed by a single update operation.

10. A large-scale data transfer system, comprising program code stored on a non-transitory computer-readable medium and executable by a processor to:
determine an architecture of a data set to be transferred from a source file system via a dynamic parallel scan;
schedule a plurality of the file serving nodes to transfer the data set from the source file system to a destination file system; and
update the data set at the destination file system based on changes to the data set of the source file system occurring as the data set is transferred to the destination file system.

11. The system of claim 10, wherein the architecture of file serving nodes is interrogated at a kernel level.

12. The system of claim 10, further comprising an interface configured to read the data set via the file system driver for the source file system, the interface configured to write the data set via the file system driver for the destination file system.

13. The system of claim 1, wherein the plurality of file serving nodes are scheduled based on a changing number of threads available at different times in the file serving nodes to transfer the data set.

14. The system of claim 10, wherein moving the data set to the destination file system is a one-time transfer event.

15. The system of claim 10, wherein moving the data set to the destination file system is at an individual file level without moving an entire data set as a block.

16. The system of claim 10, wherein the program code is further executed by the processor to maintain a log of changes to individual files in the data set of the source file system.

17. The system of claim 16, wherein the data set at the destination file system is updated based on comparing a time stamp of data at the destination file system with the log to determine changes to the data set.

18. The system of claim 16, wherein the data set at the destination file system is updated after all of the data set is transferred to the destination file system.

19. A large-scale data transfer computer program code product stored on a non-transitory computer-readable medium, which when executed by a processor:
discovers an architecture of a data set to be transferred from a source file system via a dynamic parallel scan;
schedules a threads of plurality of file serving nodes based on the architecture of a data set, wherein the threads transfer the data set from the source file system to a destination file system; and
updates the data set at the destination file system after the data set is transferred to the destination file system.

20. The computer program code product of claim 19, wherein a number of threads scales up to expedite discovering the architecture of the data set.
